(19) United States
(12) Patent Application Publication
(10) Pub. No.: US 2026/0126980 A1
(43) Pub. Date: May 7, 2026

(54) EFFICIENT DELIVERY OF UPDATE PAYLOADS IN A HYBRID CLOUD NETWORK

(71) Applicant: Dell Products L.P., Round Rock, TX (US)

(72) Inventors: Haijun ZHONG, Shanghai (CN); Xiaojun WU, Shanghai (CN); Donald MACE, Mashpee, MA (US)

(73) Assignee: Dell Products L.P., Round Rock, TX (US)

(21) Appl. No.: 18/934,346

(22) Filed: Nov. 1, 2024

(51) Int. Cl. G06F 8/65

(52) U.S. Cl. CPC G06F 8/65

(57) ABSTRACT

A disclosed payload distribution method determines, from time to time, an edge weighting for each node-to-node edge in a hybrid cloud network comprising a plurality of nodes. The plurality of nodes may include a cloud server node, a plurality of edge nodes, and a plurality of local nodes. The edges between the cloud server node and the edge nodes may be public edges, i.e., edges made available by a provider, typically for a specified cost that is tied to or otherwise influenced by the amount of data transferred and, optionally, one or more other factors including as examples, any quality of service (QoS) premiums, storage premiums, etc. Whenever an update payload ready for as identified as being ready for distribution from the cloud server node to the plurality of local nodes, payload delivery operations may be performed.

### TECHNICAL FIELD

The present disclosure pertains to cloud computing management and, more specifically, management of updates in a hybrid cloud network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may be implemented as a hybrid cloud network that include a cloud server, one or more edge servers, and local or on-premises computing clusters. In such environments, software and firmware updates, generically referred to herein as update payloads may be generated from time to time to address issues, add or modify features, etc. Once an update payload is approved, it must be downloaded from the cloud to each local node or device. In a hybrid network of any considerable scope, distributing an update payload can consume significant network bandwidth and require significant time and, accordingly, the economic cost for delivering a firmware update may be significant and may vary considerably depending upon the manner in which an update is distributed. In the worst-case scenario, as an illustrative example, an update payload might be delivered “end-to-end” for every on-premises node or device.

### SUMMARY

Common problems associated with distribution of update payloads in hybrid cloud and other complex network environments are addressed by disclosed methods and systems for efficient delivery and distribution of update payloads.

Generally, update payload delivery requires storages resources for downloading and a methodology for deploying the update payload to each appropriate on-premises device. In addition, communication transports for delivering update payloads may vary widely in the capacity, availability, and financial cost. Local network connections, on the other hand may have little marginal cost, but may have limited capacity, potentially resulting in network performance issues if used to distribute payloads.

In one aspect, a disclosed payload distribution method determines, from time to time, an edge weighting for each node-to-node edge in a hybrid cloud network comprising a plurality of nodes. The plurality of nodes may include a cloud server node, a plurality of edge nodes, and a plurality of local nodes. The edges between the cloud server node and the edge nodes may be public edges, i.e., edges made available by a provider, typically for a specified cost that is tied to or otherwise influenced by the amount of data transferred and, optionally, one or more other factors including as examples, any quality of service (QoS) premiums, storage premiums, etc.

Whenever an update payload ready for as identified as being ready for distribution from the cloud server node to the plurality of local nodes, payload delivery operations may be performed. In at least some embodiments, the payload delivery operations include identifying an initial node as a current node and, until the update payload has been delivered to each of the local nodes, iteratively performing next node operations including evaluating an edge weighting of edges from the current node to each of one or more adjacent nodes of the current node, selecting one of the adjacent nodes as a next node based on the weighting, and distributing the update payload from the current node to the next node.

In at least some embodiments, the cloud server node is identified as the initial node and may be the only source node in the network. The network may include one or more multi-node clusters, each including two or more local nodes. In addition, the network may include a multi-cluster, comprising two or more multi-node clusters provided in a single physical resource such as a hyperconverged infrastructure (HCI) appliance.

Edge weighting determinations may be influenced by one or more factors including, as non-limiting examples, a data transmission cost associated with the edge, an available capacity of the edge, and a historical reliability of the edge. The data transmission cost associated with edge may reflect a per byte cost imposed by a provider of the edge. The available capacity of an edge may be based on a maximum capacity of the edge and a present loading of the edge.

For embodiments in which the cost of using public edges i.e., edges from the cloud server node to an edge node that are made available by a third party vendor or provider, is relatively high, the payload delivery method may elect to restrict public edge transmissions to a single public edge, e.g., the lowest cost public edge. Other embodiments, may elect to permit public edge transfers via two or more public edges.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a representative topology for a hybrid cloud network;

FIG. 2 is a flow diagram depiction of an exemplary payload delivery method;

FIG. 3 illustrates a representative information handling system suitable for use in conjunction with disclosed subject matter.

### DETAILED DESCRIPTION

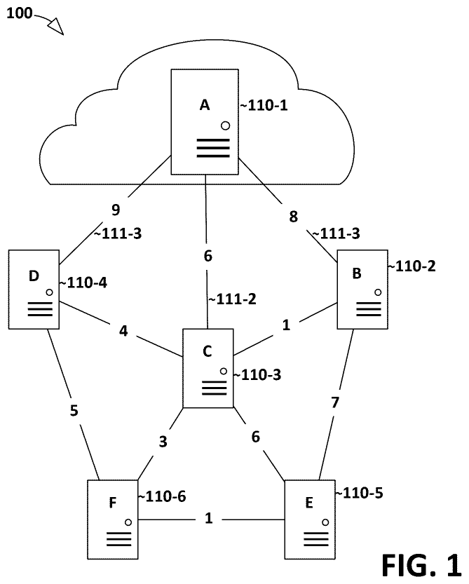

Exemplary embodiments and their advantages are best understood by reference to FIGS. 1-3, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates a representative network topology 101 for a distributed information handing system 100 comprising a plurality of server nodes, referred to herein simply as nodes 110. Although FIG. 1 illustrates a particular number of nodes 110 and a particular set of edges 111 connecting particular pairs of nodes 110, it will be appreciated to those of ordinary skill that these details are implementation specific and the other implementations may include more or fewer nodes 110, more, fewer, and/or different edges 111.

In least some embodiments, distributed information handling system 100 is hybrid system in which Node A (110-1) is a cloud server node that provide a cloud-side payload distribution service. As depicted in FIG. 1, Node A (110-1) connects to the local system via one or more edge nodes corresponding to Nodes B (110-2), C (110-3), and D (110-4) in the depicted network 100. All additional nodes may be local nodes, including the local nodes E (110-5) and F (110-6). Local nodes may be implemented in a local multi-cluster network. In at least some embodiments, the local nodes may be linked by an internal network.

The number on the node edges 111 depicted in FIG. 1 represents the weight of the network and the financial cost of network payload upload and download. For example, when comparing public networking payload transfer, the internal network is less expensive, albeit network bandwidth may change. While public cloud connections may be quicker at times, internal networks are usually faster and less expensive. In this example, the weighting values for each node 111 may reflect at least two often-competing considerations in the form of the economic costs of a network connection or transport, e.g., the cost of transmitting a 1 GB package versus the performance and/or availability of a connection. Generally speaking, public edges such as the edges 111-1, 111-2, and 111-3 between Node A (110-1) and Nodes B (110-2), C (110-3), and D (110-4) are higher cost and higher performance connections while private edge connections, including connections between edge nodes and local nodes, are less expensive, more secure, and lower performing in terms of maximum transfer rate.

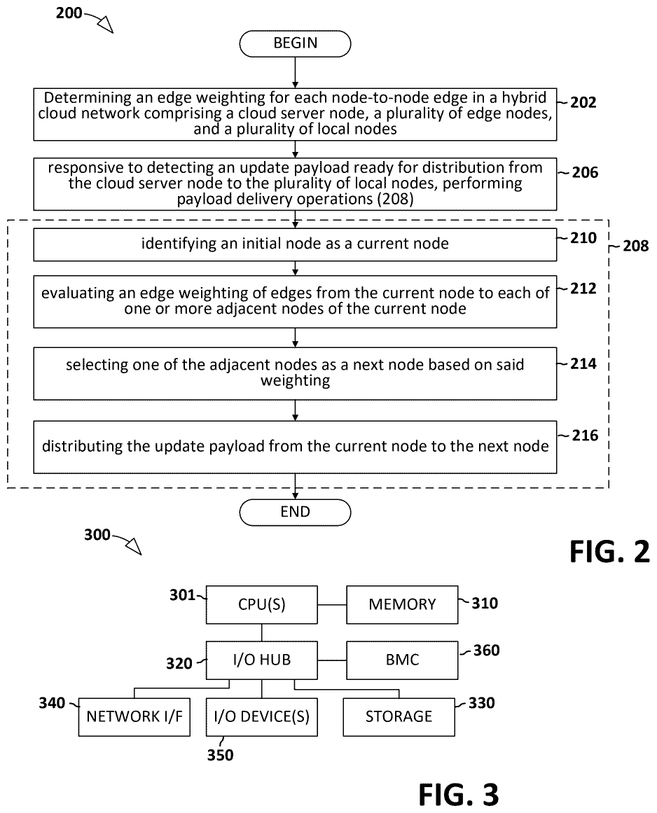

Referring now to FIG. 2, a flow diagram depicts a representative payload distribution method 200 in accordance with disclosed teachings. The method 200 depicted in FIG. 2 determines (202) from time to time, whether periodically or otherwise, an edge weighting for each node-to-node edge in a hybrid cloud network that includes, as described above with respect to FIG. 1, a cloud server node, a plurality of edge nodes, and a plurality of local nodes. Upon detecting (204) an update payload that is ready to be distributed from the cloud server node to the plurality of local nodes, the illustrated method 200 include performing (206) payload delivery operations (208). The payload delivery options 208 depicted in FIG. 2 include identifying (210) an initial node as a current node and until the update payload has been delivered to each of the local nodes, evaluating or otherwise determining (212) an edge weighting of edges from the current node to each of one or more adjacent nodes of the current node. Based on this weighting, one of the adjacent nodes may then be selected (214) as a next node. The illustrated method concludes by distributing (216) the update payload from the current node to the next node.

Referring now to FIG. 3, any one or more of the elements illustrated in FIG. 1 through FIG. 2 may be implemented as or within an information handling system exemplified by the information handling system 300 illustrated in FIG. 3. The illustrated information handling system includes one or more general purpose processors or central processing units (CPUs) 301 communicatively coupled to a memory resource 310 and to an input/output hub 320 to which various I/O resources and/or components are communicatively coupled. The I/O resources explicitly depicted in FIG. 3 include a network interface 340, commonly referred to as a NIC (network interface card), storage resources 330, and additional I/O devices, components, or resources 350 including as non-limiting examples, keyboards, mice, displays, printers, speakers, microphones, etc. The illustrated information handling system 300 includes a baseboard management controller (BMC) 360 providing, among other features and services, an out-of-band management resource which may be coupled to a management server (not depicted). In at least some embodiments, BMC 360 may manage information handling system 300 even when information handling system 300 is powered off or powered to a standby state. BMC 360 may include a processor, memory, an out-of-band network interface separate from and physically isolated from an in-band network interface of information handling system 300, and/or other embedded information handling resources. In certain embodiments, BMC 360 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A payload distribution and delivery method, comprising:
determining from time to time an edge weighting for each node-to-node edge in a hybrid cloud network comprising a cloud server node, a plurality of edge nodes, and a plurality of local nodes;
responsive to identifying an update payload ready for distribution from the cloud server node to the plurality of local nodes, performing payload delivery operations including:
identifying an initial node as a current node; and
until the update payload has been delivered to each of the local nodes, evaluating an edge weighting of edges from the current node to each of one or more adjacent nodes of the current node;
selecting one of the adjacent nodes as a next node based on said weighting; and
distributing the update payload from the current node to the next node.

2. The method of claim 1, wherein the cloud server node comprises the initial node.

3. The method of claim 1, wherein two or more of the local nodes comprise nodes of a single cluster.

4. The method of claim 1, wherein the local nodes include a multi-cluster comprising two or more clusters.

5. The method of claim 4, wherein the multi-cluster is implemented in a single hyperconverged infrastructure (HCI) appliance.

6. The method of claim 1, wherein an edge weighting is influenced by factors selected from the group consisting of: a data transmission cost associated with the edge and an available capacity of the edge; and a historical reliability of the edge.

7. The method of claim 1, wherein the data transmission cost associated with edge reflects a per byte cost imposed by a provider of the edge.

8. The method of claim 1, wherein the available capacity of an edge is based on a maximum capacity of the edge and a present loading of the edge.

9. The method of claim 1, wherein the network includes a plurality of public edges comprising each edge from the cloud server node to an edge node and wherein the update payload is delivered to the local nodes via only one of the public edges.

10. The method of claim 1, wherein the network includes a plurality of public edges comprising each edge from the cloud server node to an edge node and wherein the update payload is delivered to the local nodes via two or more of the public edges.

11. An information handling system, comprising:
a central processing unit (CPU); and
a system memory, accessible to the CPU, including processor executable program instructions, that, when executed by the CPU, cause the system to perform operations comprising:
payload distribution and delivery method, comprising:
determining from time to time an edge weighting for each node-to-node edge in a hybrid cloud network comprising a cloud server node, a plurality of edge nodes, and a plurality of local nodes;
responsive to identifying an update payload ready for distribution from the cloud server node to the plurality of local nodes, performing payload delivery operations including:
identifying an initial node as a current node; and
until the update payload has been delivered to each of the local nodes, evaluating an edge weighting of edges from the current node to each of one or more adjacent nodes of the current node;
selecting one of the adjacent nodes as a next node based on said weighting; and
distributing the update payload from the current node to the next node.

12. The information handling system of claim 11, wherein the cloud server node comprises the initial node.

13. The information handling system of claim 11, wherein two or more of the local nodes comprise nodes of a single cluster.

14. The information handling system of claim 11, wherein the local nodes include a multi-cluster comprising two or more clusters.

15. The information handling system of claim 14, wherein the multi-cluster is implemented in a single hyperconverged infrastructure (HCI) appliance.

16. The information handling system of claim 11, wherein an edge weighting is influenced by factors selected from the group consisting of: a data transmission cost associated with the edge and an available capacity of the edge; and a historical reliability of the edge.

17. The information handling system of claim 11, wherein the data transmission cost associated with edge reflects a per byte cost imposed by a provider of the edge.

18. The information handling system of claim 11, wherein the available capacity of an edge is based on a maximum capacity of the edge and a present loading of the edge.

19. The information handling system of claim 11, wherein the network includes a plurality of public edges comprising each edge from the cloud server node to an edge node and wherein the update payload is delivered to the local nodes via only one of the public edges.

20. The information handling system of claim 11, wherein the network includes a plurality of public edges comprising each edge from the cloud server node to an edge node and wherein the update payload is delivered to the local nodes via two or more of the public edges.
